(19) United States
(12) Patent Application Publication
(10) Pub. No.: US 2021/0334758 A1
(43) Pub. Date: Oct. 28, 2021

(54) System and Method of Reporting Based on Analysis of Location and Interaction Between Employees and Visitors

(71) Applicant: OOO ITV Group, Moscow (RU)

(72) Inventors: Egor Petrovich Suchkov, Tuapse (RU); Vardan Taronovich Margaryan, Maykop (RU); Grigorij Olegovich Alekseenko, Irkutsk (RU); Alan Zhasharbekovich Ataev, Moscow (RU); Karen Vitalyevich Nalchadzhi, Nalchik (RU)

(21) Appl. No.: 17/073,405

(22) Filed: Oct. 19, 2020

(30) Foreign Application Priority Data
Apr. 24, 2020 (RU) 2020114543

(51) Int. Cl. G06Q 10/10; G06N 3/04; G06K 9/00; G06K 9/62

(52) U.S. Cl. CPC G06Q 10/105; G06N 3/0427; G06F 3/04847; G06K 9/6215; G06K 9/00624; G06K 9/00335

(57) ABSTRACT

This invention relates to the use of artificial neural networks in computer vision, and more specifically to the systems and methods for analyzing and processing video data and metadata received from video cameras for automatic generation of reports based on the results obtained and thus providing control over the actions of employees. A system for generation of reports based on analysis of location and interaction between employees and visitors, comprising a memory, image capture device, a graphical user interface (GUI) and data processing device. The data processing device configured to perform receiving object video and metadata from image capture device or from the system memory, analyzing the received metadata of objects and video data using artificial neural network (ANN) to distinguish employees and visitors by presence of a uniform, identify each detected employee, as well as to further analyze the location and interaction of employees and visitors according to the user-defined system operation parameters, fndautomatic generation report.

### RELATED APPLICATIONS

This application claims priority to Russian Patent Application No. RU 2020114543, filed Apr. 24, 2020, which is incorporated herein by reference in its entirety.

### FIELD OF THE INVENTION

This invention relates to the use of artificial neural networks in computer vision, and more specifically to the systems and methods for analyzing and processing video data and metadata received from video cameras for automatic generation of reports based on the results obtained and thus providing control over the actions of employees.

### BACKGROUND

Recently, the issue of quality control of customer service in the retail sector has gained a great popularity. The quality of customer service is very important for the retail outlet owners; therefore, they aim to control the level of customer service provided by the employees in their store. Good customer service, namely quick and efficient, contributes to the growth of customer flow and corresponding sales growth.

Many different methods for collecting and processing data on the activities of customers in the sales areas are known from the field of invention. Systems with various sensors for counting visitors and analyzing their way through the store have become very widespread (see US 2004/0111454 A1, CN 105122270 B). Such solutions can show the owner the products that are in demand among the customers, help calculate the number of people, identify the time of the largest customer flow, but are unable to provide control over the work of the store staff.

In addition, in the field of invention, there is a solution disclosed in the international application WO 2019/010557 A1, pub. 17 Jan. 2019, which reveals the various options for implementing the systems and methods for collecting data related to the service sector. The method contains the following stages: (a) placing at least one color and depth sensor in the buyer/customer service area, whereby the sensor faces the customers in the said service area; (b) creating at least one color image and at least one depth map of the specified service area using at least one color and depth sensor; (c) using the processor to process at least one color image mentioned to retrieve the first set of customer descriptors for at least one customer in the specified service area, whereby the mentioned first set of customer descriptors is intended to describe at least one customer based on at least one color descriptor; d) using the processor for processing at least one depth map mentioned to retrieve the second set of customer descriptors for at least one customer in the specified service area, whereby the second a set of customer descriptors is intended to describe at least one customer based on at least one depth descriptor; (e) uploading the specified first and second sets of customer descriptors to the server for further processing.

To implement such a system, the owner should purchase the appropriate sensors and install them in their store. Therewith, the actions of buyers/customers are analyzed, while the work of employees is not controlled in any way. Thus, such a solution is complex and expensive to implement, as well as ineffective in terms of control over the customer service.

To ensure proper security and control over employees, many modern retail outlets apply video surveillance systems. The presence of such systems has a positive impact on discipline and performance of employees. Video data from the cameras can be viewed by the system operator in real time or recorded for later viewing and analysis. However, monitoring the video from multiple cameras can require much labor and time resources. Under these conditions, determining whether a good customer service is being provided can be problematic. Therefore, it is now common to use automated video collection and processing systems. This approach is more efficient and accurate in terms of data analysis and also eliminates errors caused by human factor.

In the context of this application, video systems include hardware and software tools that use computer vision methods for automated data collection based on streaming video analysis (video analysis). Such video systems are based on algorithms of image processing, including algorithms of recognition, segmentation, classification, and identification of images, allowing to analyze the video without direct human participation. In addition, up-to-date video systems allow automatic analysis of video and metadata from cameras and comparison of these data with the data available in the database.

Thus, a solution which is the closest to the stated solution in technical terms is the solution known from the field of invention and disclosed in the application US 2008/0018738 A1, pub. 24 Jan. 2008, which describes the video surveillance system for the retail business process, which includes: a video analytics tool for processing the video generated by the video camera and for generating the video primitives relative to video; a user interface for determining at least one activity of interest in relation to the area being monitored, whereby each action of interest identifies at least one rule or query regarding the area being monitored; and an activity output tool for processing the generated video primitives based on each particular activity of interest and determining whether the activity of interest occurred in the video. In addition, this system in one of its implementations contains a report generation tool associated with the warning interface tool to generate a report based on one or multiple warnings about a particular activity.

Although this solution characterizes the video data analysis on the basis of user-defined actions or events of interest, as well as the generation of reports, it differs significantly from the stated solution at least by the main video data processing operations and the means used for this processing. In addition, the known solution does not specify the difference between employees and customers, which makes the analysis of their interaction impossible.

Our solution is mainly aimed at speeding up and improving the accuracy of video and metadata processing, and, accordingly, at ensuring the proper control over employees and providing high quality service to visitors. Currently, the use of artificial neural networks is one of the advanced technologies for data processing and analysis.

Artificial neural network (ANN) is a mathematical model and its hardware and/or software implementation, built on the principle of organization and functioning of biological neural networks (networks of nerve cells of living organisms). One of the main advantages of the ANN is the possibility of its training, in the process of which the ANN can independently detect complex dependencies between input and output data.

It is the use of one or even several ANN for video and metadata processing, as well as the use of standard video surveillance and video data processing tools that makes the stated solution easier to implement, as well as more accurate and functional in comparison with solutions known from the field of invention.

### DISCLOSURE OF THE INVENTION

This technical solution is aimed to eliminate the disadvantages of the previous background of the invention and develop the existing solutions.

The technical result of the stated group of inventions is the automatic generation of reports based on the analysis of location and interaction of employees and visitors, performed using at least one artificial neural network.

This technical result is achieved by the fact that the system for generating reports based on the analysis of location and interaction of employees and visitors comprise the following elements: a memory configured to store a database containing at least photos of employees and uniforms, as well as to store video data and related metadata; at least one image capture device configured to receive real-time video data from the control area; a graphical user interface (GPI) containing data input and output means to enable the user setting the system parameters; and at least one data processing device configured to: receive video data and object metadata from at least one image capture device or from a system memory; analysis of the resulting metadata of objects and video data using at least one artificial neural network (ANN) to distinguish employees and visitor by uniform availability, identify the identity of each detected employee, and further analysis of location and interaction of employees and visitors, according to the user-defined parameters of the system operation; automatically generate at least one report based on the results of the mentioned analysis for the time interval specified by the system user.

This technical result is also achieved through the method of generating the reports based on the analysis of location and interaction of employees and visitors performed by a computer system comprising at least a graphical user interface with data input and output tools to enable the user setting the system operation parameters; a data processing device and a memory storing a database containing at least photos of employees and images of their uniforms, as well as the video data and the respective metadata; whereby the method contains the stages at which the following operations are performed: receiving video and object metadata from at least one image capture device or from a system memory; whereby each at least one image capture device mentioned is configured to receive real-time video data from its area of control; analyzing the received metadata of the objects and video data using at least one artificial neural network (ANN) to distinguish employees and visitors by availability of the uniform, identify the identity of each detected employee, and further analyzing the location and interaction of employees and visitors according to the user-defined system operation parameters; automatic generation of at least one report based on the results of the mentioned analysis for the time interval specified by the system user.

In one specific version of the stated solution, during the analysis, at least one ANN attempts to identify the uniform on each recognized person by visual similarity by comparing an image of a person's clothing received from at least one image capture device with at least one uniform image stored in the system database; if the uniform is detected on the person, the system assumes that the person is an employee, and if the uniform is not detected, the system assumes that the person is a visitor; whereby, if the system determines that the person is an employee, another ANN identifies the said employee by comparing the recognized face of the employee with photos of employees' faces stored in the system database.

In other specific version of the stated solution, the system is additionally configured for automatic replenishment of a database containing at least photos of faces of employees and images of their uniforms for training of at least one ANN; whereby replenishment of the database and training of at least one ANN are continuous processes.

In another specific version of the stated solution, GUI input means include at least the following elements: a unit for setting the maximum distance from the employee to the visitor, a unit for setting the minimum time for keeping the specified distance, a unit for setting the maximum allowable time in seconds during which the visitor should be approached by the employee, a unit for visual assigning of at least one control zone on the frame, and the output means is at least a display unit.

In another specific version of the stated solution, when setting the system operation parameters before the analysis, the system user sets specific data in the unit for setting the maximum distance from the employee to the visitor and in the unit for setting the minimum time of keeping the specified distance; whereby, if the subsequent analysis determines that the distance between the employee and the visitor is less or equal to the maximum distance, then it is assumed that the employee came to the visitor; whereby, if the mentioned distance does not exceed the maximum distance, then it is assumed that the employee talks to the visitor.

In another specific version of the stated solution, a report in the form of a table containing data about each particular employee, the time spent by them to approach a new visitor, and the time spent by them on talking to each visitor is generated based on the received data after the analysis.

In another specific version of the stated solution, a report is generated in the form of a table containing data on the episodes when the new visitor was not approached by the employee for more than N seconds based on the received data after the analysis; whereby N is a positive integer number specified in the system settings using the unit for setting the maximum allowable time in seconds during which a new visitor should be approached by the employee.

In another specific version of the stated solution, a report in the form of a graph is generated based on the received data after the analysis for each control zone for a specified period of time, containing data on the number of employees in a set control zone; whereby, X scale indicates the time and Y scale indicates the number of employees; whereby the mentioned control zone is either set in the process of setting up the system using the block for visual setting of at least one control zone on the frame, or, unless otherwise specified, the control zone is the entire field of vision of the image capture device.

In another specific version of the stated solution, a report is generated based on the data received after the analysis in the form of a table containing data on how much time the employees spend in different control zones; whereby the control zones are different premises, each of which has at least one image capture device; whereby, if the employee falls into the field of vision of at least one image capture device, then the system assumes that they are in the corresponding control zone and if the employee is not present in the field of vision of at least one image capture device, then the system assumes that the employee is absent from their workplace.

In another specific version of the stated solution, a report is generated for each specific employee for the user-defined period of time; whereby the report specifies how much time the employee spends in each specific control zone and how much time they are absent from the workplace.

In another specific version of the stated solution, the mentioned report is generated for each specific control zone for the user-defined period of time; whereby the report specifies how much time each specific employee has spent in this control zone.

In another specific version of the stated solution, if there is only one employee in the control area who is a cashier, the data obtained after the analysis is used to generate a report containing the data on how much time passes before each visitor approaches the cashier desk; whereby the report also contains data on the time when the particular visitor approached the cashier desk and how much time it spent at the cashier desk; whereby, for the mentioned report to be generated, the system user visually presets the control zone on the frame, the presence of the visitor in which informs the system that the visitor has approached the cashier desk.

In another specific version of the stated solution, at least one mentioned report is generated during the analysis of the archived video data stored in the system memory.

In another specific version of the stated solution, at least one mentioned report is automatically generated with a preset frequency which is set by the system user through the use of GUI tools.

In another specific version of the stated solution, at least mentioned one report is displayed on the screen for the system user by means of the display unit or is automatically sent to a preset system user.

In addition to the above, this technical result is also achieved through a computer-readable data carrier containing instructions executable by the computer processor for implementation of methods for report generation based on analysis of location and interaction between employees and visitors.

### BRIEF DESCRIPTION OF DRAWINGS

FIG. 1—block diagram of the system for generation of reports based on analysis of location and interaction between employees and visitors.

FIG. 2—block diagram of the version of the graphical user interface used for setting the system operation parameters;

FIG. 3A—example of employee control diagram of employees in the first control zone (in the sales area);

FIG. 3B—example of employee control diagram in the second control zone (in the warehouse);

FIG. 4—block diagram of the method for generation of reports based on analysis of location and interaction between employees and visitors.

### EMBODIMENT OF THE INVENTION

Description of the approximate embodiments of the claimed group of inventions is presented below. However, the claimed group of inventions is not limited only to these embodiments. It will be obvious to persons who are experienced in this field that other embodiments may fall within the scope of the claimed group of inventions described in the claim.

The claimed technical solution in its various embodiment options can be implemented in the form of computing systems and methods implemented by various computer means, as well as in the form of a computer-readable data carrier, which stores the instructions executed by the computer processor.

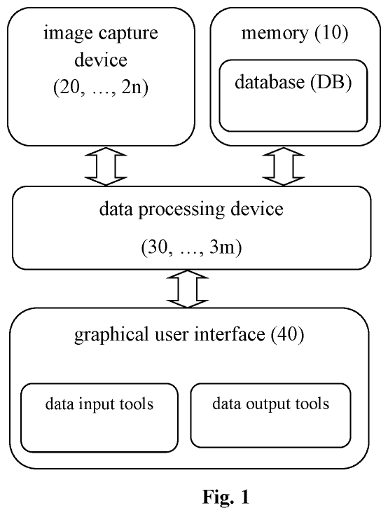

FIG. 1 shows a block diagram of the system for generation of reports based on analysis of location and interaction between employees and visitors. This system, in its complete set, includes the following elements: memory (10) configured to store the database (DB), video data and metadata; at least one image capture device (20, . . . , 2n); at least one data processing device (30, . . . , 3m), and a graphical user interface (40) installed on each of the mentioned data processing devices. Memory, data processing devices and image capture devices can be combined into a single system by using a local network or via the Internet.

In this context, computer systems may be any hardware- and software-based interconnected technical tools.

An image capturing device is a video camera.

The data processing device may be a processor, microprocessor, computer, PLC (programmable logic controller) or integrated circuit, configured to execute certain commands (instructions, programs) for data processing.

The graphical user interface (GUI) is a system of tools for user interaction with the computing device based on displaying all system objects and functions available to the user in the form of graphical screen components (windows, icons, menus, buttons, lists, etc.). Thus, the user has random access via data input/output devices to all visible screen objects—interface units—which are displayed on the display. For example, data input devices can be, but are not limited to, mouse, keyboard, touchpad, stylus, joystick, trackpad, etc.

Memory devices may include, but are not limited to, hard disk drives (HDDs), flash memory, ROMs (read-only memory), solid state drives (SSDs), optical drives, etc. And in the case when the memory device is a server, it can both store data and process it, for example, to generate metadata. In the context of this application, the memory stores a database (DB), which contains at least photographs of employees' faces and images of their uniforms, as well as video data and corresponding metadata.

It should be noted that the described system may also include any other devices known in the background of the invention, such as sensors of various types, data input/output devices, display devices, etc.

A detailed example of the above-mentioned system's operation for generating reports based on analysis of location and interaction between employees and visitors will be described below. All stages of the system described below are also applicable to the implementation of the stated method of generation of reports based on analysis of location and interaction between employees and visitors, which will be discussed in more detail below.

Let's consider the operation principle of the stated system configured primarily to ensure control over the employees. Let's assume that the system of analysis-based report generation, as well as the corresponding software is installed in a store, the owner of which wants to control the work of his employees to improve the level of customer service. Each employee has their own uniform (either the same or different, depending on the position). The work space/shop is equipped with the necessary number of image capture devices. Their number depends on the area of the controlled premise and the number of the controlled premises in the store. Each image capture device, in this case a video camera, is positioned in such a way to ensure continuously receipt of real-time video data from its field of vision. In this case, video cameras may contain an object tracker configured to generate object metadata. In another version, if the system uses the simplest cameras, the object tracker can be installed on the server (acting as the system memory) to process the video data received from the system's cameras and to generate the corresponding metadata. In the contest of this application, the object tracker is a software algorithm for determining location of the moving objects in the video data. By using the mentioned tracker, it is possible to detect all moving objects in the frame and determine their specific spatial coordinates.

The object metadata received in a certain way (from video cameras or from the server) is stored in the system memory, along with the corresponding video data, to enable further analysis of the archive data. And in case all video cameras of the system contain an object tracker, the video data and metadata received in real time can be immediately transferred to the data processing device. It should be noted that metadata is detailed data on all objects moving in the field of vision of each camera (location, movement trajectories, face descriptions, clothes descriptions, etc.).

As for the control zone, it is either set by the system user on the frame or is the entire field of vision of the camera view in the control zone. In some versions (when a large premise is monitored), several video cameras may be linked to one control zone. A single camera may be sufficient for a small premise. It should be mentioned that it is preferable to place the image capture devices in commercial premises in such a way as to fully cover the entire premise (cameras' fields of vision may slightly overlap/overlay to get a complete picture). Thus, when the analyzing images, it is easy to detect each person, to get a good one or several images of them from the video data, as well as to track the route of their movement around the store, and analyze their interaction with other people (by metadata and video data).

Further, at least one data processing device, such as a computer graphics processor, performs the main work. Thus, interaction between the user and the system is performed through the use of the graphical user interface (GUI) installed on each data processing device; whereby the said GUI contains the necessary data input and output means.

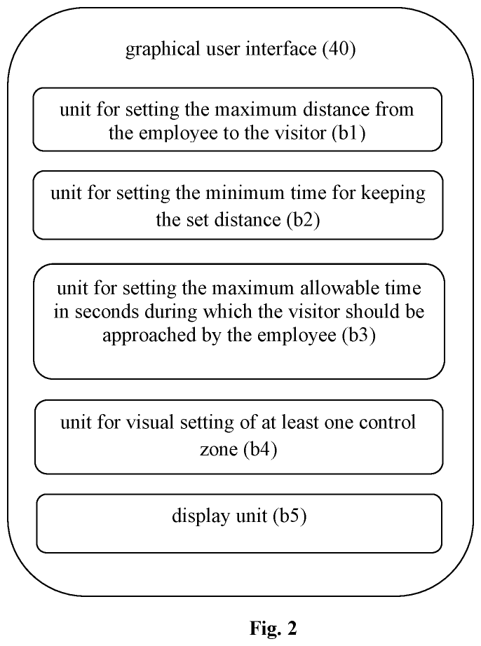

As shown in FIG. 2, in one specific version of the application GUI input means include at least the following: a unit for setting the maximum distance from the employee to the visitor (b1), a unit for setting the minimum time of keeping the specified distance (b2), a unit for setting the maximum allowable time in seconds during which the visitor should be approached by the employee (b3), a unit for visual setting of at least one control zone on the frame (b4). And the output means include at least a display unit (b5). In addition, GUI may contain any other additional or replacing units, depending on the control requirements of the store owner for generation of the necessary reports after data analysis. For example, the GUI may contain a unit for setting/choosing the date and time interval (b6).

So, the data processing device (one or several) in one version can continuously receive all video data and the corresponding metadata from at least one image capture device in real time mode (if video cameras contain the object tracker). In this case, the data processing device in the other implementation version can receive video data and metadata directly from the server which serves as a system memory at any time. In this case, the server receives video data from the image capture devices in real time and generates metadata corresponding to them, whereupon it stores the mentioned video data and metadata to provide analysis by the archived data.

Further, the video and metadata of the objects received in a certain way are analyzed by the data processing unit using at least one artificial neural network (ANN) for (a) distinguishing employees and visitors by the presence or absence of uniforms, (b) identifying each detected employee, as well as for (c) further analyzing the location and interaction between employees and visitors in accordance with user-defined system operation parameters through the use of GUI.

In this case, during the analysis, the system first recognizes all people on each frame of video data, and then at least one ANN tries to identify the uniform on each recognized person. The said identification of the uniform shall be performed by visual similarity by comparing an image of a person's clothing with at least one image of the uniform stored in the system database.

If the recognized image of a person's clothing matches sufficiently with at least one image of the employees' uniform from the database in the process of identification, the system stops the identification process with a positive result. This approach allows not to waste available computing resources of the system and speeds up the comparison process. The identification principle is as follows: the artificial neural network receives a separate image of the person's clothing, whereupon it generates some number vector—image descriptor. The database stores a sample of reference images of all uniforms used in the store in question, including a descriptor corresponding to each image of the uniform. ANN sues these descriptors to compare the images. Moreover, the ANN is trained in such a way that the smaller the angle between these number vectors in space, the more likely it is that the images will match. A cosine angle between the number vectors (vectors from the database and the resulting image vector of clothes of a person subject to check the presence of uniform) is used as a metric for comparison. Accordingly, the closer the cosine angle between the vectors to one, the more likely it is a person's clothing is a uniform. When setting up the system, the user can specify the range of values, at which the system will make a decision about presence of the uniform. Otherwise, the system will assume that a person is not wearing a uniform and therefore is a buyer/customer/store visitor. In this case, the artificial neural network compares sequentially the received images of each recognized person's clothing with all the images of different uniforms available in the database until it gets a sufficient match.

If the uniform is detected on the person, the system assumes that the person is an employee, and if the uniform is not detected, the system assumes that the person is a visitor. Further, if the system determines that the person is an employee, the data processing device moves on to the next stage—(b) identification of the employee. The said identification of each detected employee by availability of the uniform is performed by comparing the detected employee's face with the employee's face photographs stored in the same database of the system. It shall be mentioned that identification shall be performed using either the already used ANN or (which is preferable) another/separate ANN. And the principle of identification is similar to the above, with the only difference that in this case the artificial neural network selects a separate image of the employee's face from the image of the person in the uniform, then gives the image descriptor, which is similarly compared to employee face photo descriptors stored in the system database along with the mentioned photos of faces. It shall be mentioned that the video data analysis can be performed continuously or following a signal from a system user within a certain time interval, i.e. for a point of sale with operating hours from 10:00 to 22:00, it is necessary to analyze the video data only for this time interval to save the system memory and computing resources. Thus, at other times (for example, at night) the system can operate as a standard video surveillance system, recording video data into an archive for security and protection of premises.

It should be mentioned that the considered system is additionally configured to automatically replenish the database containing at least photos of employees' faces and images of their uniforms, as well as to train at least one ANN applied. Thus, replenishment of the database and training of at least one ANN is a continuous process, since the appearance of the uniform and facial features of employees change over time. In the context of the claimed solution, training of each artificial neural network is carried out on the basis of the replenished database. The system user/operator can specify a certain time at which training of the artificial neural network will be carried out. For example, once a day. In this case, the mentioned training can be performed, for example, by a data processing device or a cloud service, or any other computing device. It should be specified more specifically that the database contains a selection of images of each type of uniform, as well as a selection of photos of faces for each particular employee. The selection is a set of images. A system user can specify a specific number of images to be contained in each selection when configuring the system operation. Thus, the selection of images of each uniform type contains N last uploaded images for this uniform type, where N is a positive integer number preset by the user. In the same way, a selection of photos of faces for each particular employee is generated. Suppose that the user has set N=5 when setting up the system operation. In this case, five images are contained in each selection. Thus, whenever a new image (i.e. the sixth one) is added, the older one should be automatically deleted and the new image is saved. In this way, the relevance of the database and the constant number of images in the selection are maintained.

Simply put, summing up the above, at least one data processing device first detects each person in the frame, then recognizes the clothing on the person, and then analyzes a set of images of each type of uniform, to identify a match. When a person's clothing matches a store uniform, the system detects that the person is an employee, then recognizes the face of the person in the uniform, and sequentially analyzes a set of photos of each employee's face to identify a match and, therefore, identify the employee.

To perform the next stage, namely, analysis of (c) location and interaction between employees and visitors, the system user should set specific system operation parameters, based on which the video data, the corresponding metadata, and the data received after distinguishing the employees and visitors, as well as after identifying the employees will be analyzed. Thus, before the analysis, the user sets the system operation parameters by using the GUI tools specified earlier. Namely, in one of the specific versions, the user sets the specific data in the unit for setting the maximum distance from the employee to the visitor (b1) and in the unit for setting the minimum time for keeping the specified distance (b2). Thus, if the subsequent analysis determines that the distance between the employee and the visitor is less or equal to the maximum distance, it is assumed that the employee approached the visitor. And if the specified distance does not exceed the maximum distance during the time which is greater than the minimum time of keeping the specified distance, then it is assumed that the employee talks to the visitor.

For example, let's consider a situation when the system user has set in (b1) 1 meter and in (b2) 30 seconds (any values can be set). It should be mentioned that the minimum time for keeping the mentioned distance is set to exclude the false cases, for example, if the employee just walked past the visitor. Thus, if an employee came to a visitor at a distance of less than 1 meter, but after 5 seconds went more than 1 meter away, the system will determine that the employee just passed by; but if the employee came to a distance of 0.8 meters to the buyer and this distance is kept the same or within the specified 1 meter longer than the set 30 seconds, the system determines that the employee serves the visitor.

After performing the analysis on the basis of user-defined data/criteria, as well as after presetting a specific date and time range/interval (e.g. date Nov. 4, 2019, interval from 10:00 to 15:00), the system can move to the final stage—automatic generation of at least one report based on the results of the mentioned analysis for the specified time interval.

A report in the form of a table containing data about each particular employee, the time spent by them to approach a new visitor, and the time spent by them on talking to each visitor is generated based on the received data after the analysis. In this case, the report does not include cases when an employee passes by a visitor. The report table may look like the one presented as an example in Table 1.

Thus, the number of employees specified in the table depends on the real number of employees who worked on the specified day and mainly on the number of visitors served. Thus, the fact of service for each visitor is recorded in the table. The time in the table is specified in the format “HH:MM:SS”.

TABLE 1

| | | | Time an | Time range of |
|---|---|---|---|---|
| | | Time an | employee | serving the |
| | Time a new | employee | goes away | visitor |
| Employee | visitor | approaches | from a | by an |
| name | appears | a visitor | visitor | employee |
| Full name 1 | 10:12:15 | 10:12:27 | 10:13:34 | 00:01:07 |
| Full name 2 | 10:15:00 | 10:15:45 | 10:23:59 | 00:08:14 |
| Full name 3 | 12:38:30 | 12:39:01 | 12:42:12 | 00:03:11 |

From this report, the employees serving more visitors can be identified easily and low activity of employees can be tracked. It is also possible to determine the employees who spend much and few time on talking to each visitor.

In another specific version of the stated solution, a report is generated in the form of a table containing data on the episodes when the new visitor was not approached by the employee for more than N seconds based on the received data after the analysis. Thus, N is a positive integer number specified in the system settings using the unit for setting the maximum allowable time in seconds during which a new visitor should be approached by the employee (b3). Let's assume the system user has set N=20 sec. Then the table will indicate the time a new visitor appears, and if no employee approaches the visitor within 20 seconds, the data will be recorded in the table. The table may look the same as Table 1, while containing only the data of those episodes in which the difference in time to approach a new visitor and the time of entry of a new visitor exceeds the set 20 seconds or episodes when the visitor was not approached by any employee of the store. In another version, the table may contain all episodes of serving each new visitor; thus, if the visitor waits for an employee more than N seconds, such episodes will be marked by color in the column “Employee reaction time” in the report. An approximate version of the report is presented in Table 2. This example shows all the episodes of serving the visitors with color marking of the episodes, when the employee reaction time exceeded the maximum allowable time.

According to this report, it is easy to determine the employees who are slow to respond to the emergence of a new visitor and find out whether it is associated with a large flow of visitors at certain hours.

TABLE 2

| | | | Time an | Time range of | |
|---|---|---|---|---|---|
| | | Time an | employee | serving the | |
| | Time a new | employee | goes away | visitor | |
| Employee | visitor | approaches | from a | by an | Employee |
| name | appears | a visitor | visitor | employee | reaction time |
| Full name 1 | 12:38:15 | 12:39:48 | 12:43:53 | 00:04:05 | 00:01:33 |
| Full name 2 | 15:45:12 | 15:45:32 | 15:47:40 | 00:02:08 | 00:00:20 |
| Full name 3 | 19:20:00 | 19:22:13 | 19:23:45 | 00:01:32 | 00:02:13 |

In another version of the system implementation, a report is generated after the analysis in the form of a graph for each specific control zone for a time period set by the user. Such graph contains data on the number of employees in a preset control zone, while the X scale indicates the time and the Y scale—the number of employees. The mentioned control zone is set in the process of the system operation setup, in the unit for visual setting of at least one control zone on the frame (b4) by selecting the required area on the frame. For example, the control zone covering the space near the cash register can be visually set. Or, unless otherwise specified, the control zone is the whole field of vision of the image capture device. In this case, several cameras may be linked to one control zone. For example, camera1, camera2 and camera3 are linked to zone 1. If an identified employee of the store falls into the field of vision of at least one video camera of zone 1, the system assumes that the employee is in the zone 1. If an employee is not in any control zone, the system assumes that the employee is not at their workplace. It should be mentioned that for the case when the control zone is the whole area of the camera's field of vision, the system may operate without entering additional data in the GUI units. To perform the analysis, it is enough to know only the video time range and the specific date for which the video should be analyzed. Thus, it is possible to set the frequency of report generation and receive a report, for example, daily at 10:00 for the past day for the time period from 10:00 to 22:00.

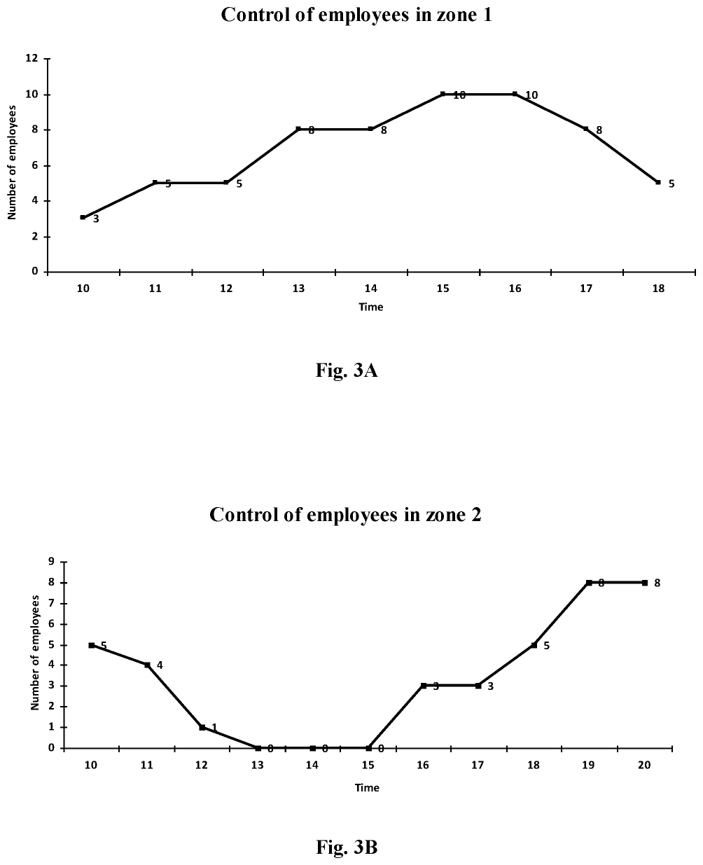

The individual control zones may include: sales areas (one or several), warehouses, cash desk area, etc. For example, FIG. 3A shows a graph of dependence of the number of employees in the store depending on the time of day. The graph is drawn up for the zone of the sales area and it shows that the store floor has the largest number of employees from 14:00 to 17:00, which means the largest flow of customers at these hours. FIG. 3B shows a graph of the number of employees in the store depending on the time of day in the warehouse. Based on the graph, it is clear that employees are working in the warehouse in the morning and evening hours, while in the daytime hours they are in another premise, for example, in the sales area.

In addition, in order to better control the employees' work, it is necessary to understand how much time each employee spends in each control zone and how much time the employee is absent from the workplace (that is, for how long he is not detected by any video camera of the system). Following the analysis, a report is generated in the form of a table containing data on how much time employees spend in different control zones. In this case, the control zones are different premises with at least one image capture device in each of them. Such zones are sales areas, warehouses, etc. Thus, if an employee gets into the field of vision of at least one image capture device, the system assumes that they are in the control zone corresponding to it, and if the employee is not in the field of vision of any image capture device, the system assumes that the employee is not at their workplace. In other words, another zone characterizing the uncontrolled area appears in the report. There are no cameras in this zone; therefore, if an employee is not in any controlled zone, the system automatically assigns them to the uncontrolled zone.

A report of this kind can be generated in two different forms.

For each specific employee within the time interval set by the system user, whereby the report indicates how much time the employee spends in each specific control zone and how much time the employee is absent from the workplace (see Table 3).

For each specific control zone for the user-defined time period, whereby the report indicates how much time each employee spent in this control zone (see Table 4).

For example, let's assume that zone 1 is the first sales area, zone 2 is the second sales area, zone 3 is a warehouse, and one more zone in the report is an uncontrolled zone. In this case, during the system setup, the user specifies that the working day of each employee is 10 hours.

TABLE 3

| | ZONES | | | |
|---|---|---|---|---|
| | | | | Uncontrolled |
| FULL NAME | Zone 1 | Zone 2 | Zone 3 | Zone |
| Full name 1 | 04:12:00 | 02:38:17 | 02:19:31 | 00:50:12 |
| Full name 2 | 00:45:15 | 03:15:15 | 04:54:20 | 01:05:10 |
| Full name 3 | 05:10:10 | 01:26:00 | 01:20:15 | 02:03:35 |

TABLE 4

| | FULL NAME | | | | |
|---|---|---|---|---|---|
| | Full | Full | Full | Full | Full |
| ZONES | name 1 | name 2 | name 3 | name 4 | name 5 |
| Zone 1 | 04:12:00 | 00:45:15 | 05:10:10 | 02:15:17 | 04:40:00 |
| Zone 2 | 02:38:17 | 03:15:15 | 01:26:00 | 03:38:06 | 03:00:05 |
| Zone 3 | 02:19:31 | 04:54:20 | 01:20:15 | 01:59:15 | 02:17:39 |

Therefore, Table 3 makes it easy to understand which of the employees spends on lunch more time than the allotted time, and Table 4 shows which room is the busiest for employees' work.

Next, let's consider one more approximate situation. Suppose our system is installed in a small grocery store (point of sale), where only one employee works who stands at the cash desk and serves the visitors. The customer comes to the store and puts the necessary items in the basket, and then goes to the cashier desk. For this case, namely to control the work of one employee/cashier, the system user visually presets the control zone (area) on the frame, in which the visitor is assumed by the system as having approached the cashier desk.

In this case, after the analysis, a report containing data on how much time passes before each visitor comes to the cashier desk can be generated; thus, the report also contains data on the time when a particular visitor came to the cashier desk and how much time they spent at the cashier desk, that is, how long it took the cashier to serve a particular customer (see Table 5).

TABLE 5

| | | | | | Time range |
|---|---|---|---|---|---|
| | | | | Time | of the |
| | | | | range of | visitor's |
| | Time the | Time the | | serving a | stay in the |
| | visitor | visitor | | visitor | store before |
| | appears in | approaches | Time the | by an | approaching |
| | the store | the cashier | departure | employee | the cashier |
| Visitors | (t1) | desk (t2) | leaves (t3) | (t3-t2) | desk (t2-t1) |
| 1 | 10:03:12 | 10:04:17 | 10:05:39 | 00:01:22 | 00:01:05 |
| 2 | 11:40:30 | 11:53:46 | 11:57:59 | 00:04:13 | 00:13:16 |
| 3 | 15:27:10 | 15:31:38 | 15:34:40 | 00:03:02 | 00:04:28 |

It should be mentioned that, in this way, as described in the various options above, any kind of report can be generated, depending on the data that the owner of the point of sale wants to control. ANN easily analyzes any amount of information by any user-defined parameters or criteria. Thus, each report is usually (preferably) generated during analysis f the archived video data stored in the system memory, but, as mentioned earlier, data processing devices can receive and analyze video and metadata in real time from video cameras.

In addition, the mentioned reports can be automatically generated by a signal from the system user or at a predetermined frequency (for example, once a day, at 10:00). The reports can also be automatically sent to predefined system users (for example, by SMS or email) or saved in the system memory (if desired, the system user can view the reports at any convenient time). If at least one report is generated by a signal/command from the system user, this report may be immediately displayed to the system user via the GUI display unit (b5).

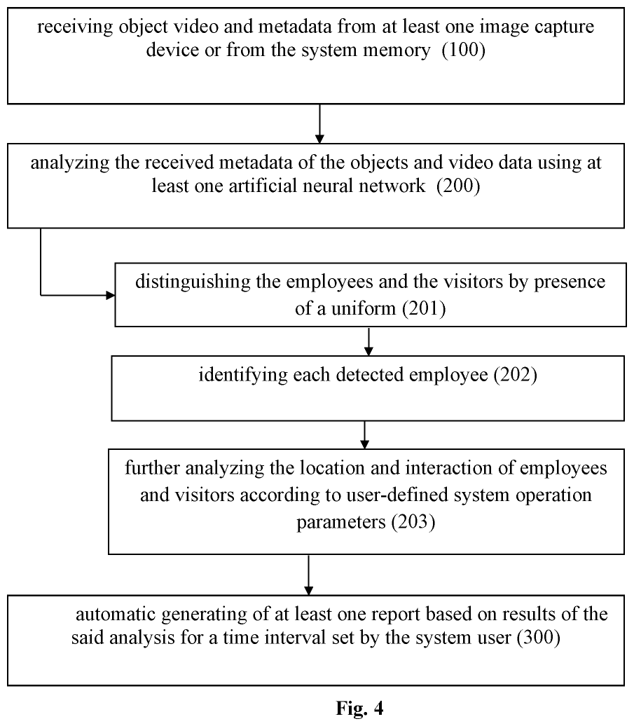

A detailed example of a specific implementation of the method for generating reports based on analysis of location and interaction between employees and visitors will be described below. FIG. 4 shows a block diagram of the one of the implementation options of the method for generating the reports based on analysis of location and interaction between employees and visitors.

The above method is performed by a computer system that contains at least a graphical user interface containing the data input and output means to enable the user setting the system operation parameters installed on the data processing device, the data processing device itself, and a memory storing a database containing at least photographs of employees' faces and images of their uniforms, as well as video data and the corresponding metadata. The claimed method in its basic version contains the stages, at which the following operations are executed:
(100) obtaining video data and metadata of objects from at least one image capture device or from the system memory; whereby the mentioned at least one image capture device is configured to obtain video data from its control area in real time;
(200) analyzing the received metadata of the objects and video data using at least one artificial neural network (ANN) for:
(201) distinguishing the employees and the visitors by presence of a uniform,
(202) identifying each detected employee, and
(203) further analyzing the location and interaction of employees and visitors according to user-defined system operation parameters; and
(300) automatic generation of at least one report based on results of the said analysis for a time interval set by the system user.

It should be mentioned once again that this method can be implemented with the help of the above-mentioned computer system and, consequently, can be extended and refined by all embodiments of the system that have already been described above to implement the system for generating reports based on analysis of location and interaction of the employees and the visitors.

Besides, the embodiment options of this group of inventions can be implemented with the use of software, hardware, software logic, or their combination. In this implementation example, software logic, or instruction set is stored on one or more of the different traditional computer-readable data media.

In the context of this description, a “computer-readable data carrier” may be any environment or medium that can contain, store, transmit, distribute, or transport the instructions (commands) for their application (execution) by a computer device, such as a personal computer. Thus, a data carrier may be an energy-independent machine-readable data carrier.

If necessary, at least some part of the various operations presented in the description of this solution can be performed in an order differing from the described one and/or simultaneously with each other.

Although the technical solution has been described in detail to illustrate the most currently required and preferred embodiments, it should be understood that the invention is not limited to the embodiments disclosed and, moreover, is intended to modify and combine various other features of the embodiments described. For example, it should be understood that this invention implies that, to the possible extent, one or more features of any embodiment option may be combined with one or more other features of any other embodiment option.

1. A system for generation of reports based on analysis of location and interaction between employees and visitors, comprising the following elements:
a memory configured to store a database containing at least photos of employees' faces and uniforms, as well as to store video data and related metadata;
at least one image capture device configured to receive video data from the control area in real time;
a graphical user interface (GUI) containing data input and output tools to enable the user setting the system operation parameters; and
at least one data processing device configured to perform the following operations:
receiving object video and metadata from at least one image capture device or from the system memory;
analyzing the received metadata of objects and video data using at least one artificial neural network (ANN) to distinguish employees and visitors by presence of a uniform, identify each detected employee, as well as to further analyze the location and interaction of employees and visitors according to the user-defined system operation parameters;
automatic generation of at least one report based on results of the said analysis for a time interval set by the system user.

2. The system according to claim 1, wherein the at least one ANN attempts to identify the uniform on each person recognized by visual similarity by comparing the image of a person's clothing received from at least one image capture device with at least one uniform image stored in the system database,
thus, if the uniform is detected on the person, the system assumes that the person is an employee, and if the uniform is not detected, the system assumes that the person is a visitor,
thus, if the system determines that the person is an employee, another ANN identifies the employee by comparing the recognized face of the person with photos of the employees' faces stored in the system database.

3. The system according to claim 2, wherein the additionally configured for automatic replenishment of a database containing at least photos of faces of employees and images of their uniforms for training of at least one ANN; whereby replenishment of the database and training of at least one ANN are continuous processes.

4. The system according to claim 1, wherein the GUI input means include at least the following elements: a unit for setting the maximum distance from the employee to the visitor, a unit for setting the minimum time for keeping the specified distance, a unit for setting the maximum allowable time in seconds during which the visitor should be approached by the employee, a unit for visual assigning of at least one control zone on the frame, and the output means is at least a display unit.

5. The system according to claim 4, wherein the setting up the system before the analysis, the system user sets specific data in the unit for setting the maximum distance from the employee to the visitor, and in the unit for setting the minimum time of keeping the specified distance,
whereby, if the subsequent analysis determines that the distance between the employee and the visitor is less or equal to the maximum distance, then it is assumed that the employee came to the visitor; whereby, if the mentioned distance does not exceed the maximum distance, then it is assumed that the employee talks to the visitor.

6. The system according to claim 5, wherein the report in the form of a table containing data about each particular employee, the time spent by them to approach a new visitor, and the time spent by them on talking to each visitor is generated based on the received data after the analysis.

7. The system according to claim 5, wherein the report is generated in the form of a table containing data on the episodes when the new visitor was not approached by the employee for more than N seconds based on the received data after the analysis; whereby N is a positive integer number specified in the system settings using the unit for setting the maximum allowable time in seconds during which a new visitor should be approached by the employee.

8. The system according to claim 4, wherein the report in the form of a graph is generated based on the received data after the analysis for each control zone for a specified period of time, containing data on the number of employees in a set control zone; whereby, X scale indicates time and Y scale indicates the number of employees;
whereby the mentioned control zone is either set in the process of setting up the system using the block for visual setting of at least one control zone on the frame, or, unless otherwise specified, the control zone is the entire field of vision of the image capture device.

9. The system according to claim 3, wherein the report is generated based on the data received after the analysis in the form of a table containing data on how much time the employees spend in different control zones; whereby the control zones are different premises, each of which has at least one image capture device;
whereby, if the employee falls into the field of vision of at least one image capture device, then the system assumes that they are in the corresponding control zone and if the employee is not present in the field of vision of at least one image capture device, then the system assumes that the employee is absent from their workplace.

10. The system according to claim 9, wherein the report is generated for each specific employee for the user-defined period of time; whereby the report specifies how much time the employee spends in each specific control zone and how much time they are absent from the workplace.

11. The system according to claim 9, wherein the mentioned report is generated for each specific control zone for the user-defined period of time; whereby the report specifies how much time each specific employee has spent in this control zone.

12. The system according to claim 4, wherein if there is only one employee in the control area who is a cashier, the data obtained after the analysis is used to generate a report containing the data on how much time passes before each visitor approaches the cashier desk; whereby the report also contains data on the time when the particular visitor approached the cashier desk and how much time they spent at the cashier desk;
whereby, for the mentioned report to be generated, the system user visually presets the control zone on the frame, the presence of the visitor in which informs the system that the visitor has approached the cashier desk.

13. The system according to claim 1, wherein the at least one report is generated when analyzing archived video data stored in the system memory.

14. The system according to claim 1, wherein the at least one report is automatically generated at a preset frequency which is specified by the system user via GUI tools.

15. The system according to claim 1, wherein the at least one report is displayed to the system user via a display unit or is automatically sent to a preset system user.

16. A method for generating reports based on the analysis of location and interaction of employees and visitors, performed by a computer system comprising at least a graphical user interface that contains data input and output tools to enable the user setting the system operation parameters, a data processing device, and a memory that stores the data containing at least photographs of employees' faces and images of their uniforms, as well as storing video data and related metadata; whereby the method contains the stages at which the following operations are performed:
obtaining video data and metadata of objects from at least one image capture device or from the system memory; whereby the mentioned at least one image capture device is configured to obtain video data from its control area in real time;
analyzing the received metadata of objects and video data using at least one artificial neural network (ANN) to distinguish employees and visitors by presence of a uniform, identify each detected employee, as well as to further analyze the location and interaction of employees and visitors according to the user-defined system operation parameters;
automatic generation of at least one report based on results of the said analysis for a time interval set by the system user.

17. The method according to claim 16, wherein the at least one ANN attempts to identify the uniform on each person recognized by visual similarity by comparing the image of a person's clothing received from at least one image capture device with at least one uniform image stored in the system database,
thus, if the uniform is detected on the person, the system assumes that the person is an employee, and if the uniform is not detected, the system assumes that the person is a visitor.
thus, if the system determines that the person is an employee, another ANN identifies the employee by comparing the recognized face of the person with photos of the employees' faces stored in the system database.

18. The method according to claim 16, wherein the replenishment of the database containing at least employees' faces and images of their uniforms is performed automatically for training of at least one ANN; whereby the replenishment of the database and training of at least one ANN are continuous processes.

19. The method according to claim 18, wherein the GUI input means include at least the following elements: a unit for setting the maximum distance from the employee to the visitor, a unit for setting the minimum time for keeping the specified distance, a unit for setting the maximum allowable time in seconds during which the visitor should be approached by the employee, a unit for visual assigning of at least one control zone on the frame, and the output means is at least a display unit.

20. The method according to claim 19, wherein the setting up the system before the analysis, the system user sets specific data in the unit for setting the maximum distance from the employee to the visitor and in the unit for setting the minimum time of keeping the specified distance,
whereby, if the subsequent analysis determines that the distance between the employee and the visitor is less or equal to the maximum distance, then it is assumed that the employee came to the visitor; whereby, if the mentioned distance does not exceed the maximum distance, then it is assumed that the employee talks to the visitor.

21. The method according to claim 20, wherein the report in the form of a table containing data about each particular employee, the time spent by them to approach a new visitor, and the time spent by them on talking to each visitor is generated based on the received data after the analysis.

22. The method according to claim 20, wherein the report is generated in the form of a table containing data on the episodes when the new visitor was not approached by the employee for more than N seconds based on the received data after the analysis; whereby N is a positive integer number specified in the system settings using the unit for setting the maximum allowable time in seconds during which a new visitor should be approached by the employee.

23. The method according to claim 19, wherein the report in the form of a graph is generated based on the received data after the analysis for each control zone for a specified period of time, containing data on the number of employees in a set control zone; whereby, X scale indicates time and Y scale indicates the number of employees;
whereby the mentioned control zone is either set in the process of setting up the system using the block for visual setting of at least one control zone on the frame, or, unless otherwise specified, the control zone is the entire field of vision of the image capture device.

24. The method according to claim 18, wherein the report is generated based on the data received after the analysis in the form of a table containing data on how much time the employees spend in different control zones; whereby the control zones are different premises, each of which has at least one image capture device;
whereby, if the employee falls into the field of vision of at least one image capture device, then the system assumes that they are in the corresponding control zone and if the employee is not present in the field of vision of at least one image capture device, then the system assumes that the employee is absent from their workplace.

25. The method according to claim 24, wherein is generated for each specific employee for the user-defined period of time; whereby the report specifies how much time the employee spends in each specific control zone and how much time they are absent from the workplace.

26. The method according to claim 24, wherein the mentioned report is generated for each specific control zone for the user-defined period of time; whereby the report specifies how much time each specific employee has spent in this control zone.

27. The method according to claim 19, wherein if there is only one employee in the control area who is a cashier, the data obtained after the analysis is used to generate a report containing the data on how much time passes before each visitor approaches the cashier desk; whereby the report also contains data on the time when the particular visitor approached the cashier desk and how much time they spent at the cashier desk;
whereby, for the mentioned report to be generated, the system user visually presets the control zone on the frame, the presence of the visitor in which informs the system that the visitor has approached the cashier desk.

28. The method according to claim 16, wherein the at least one report is generated when analyzing archived video data stored in the system memory.

29. The method according to claim 16, wherein the at least one report is automatically generated at a preset frequency which is specified by the system user via GUI tools.

30. The method according to claim 16, wherein the at least one report is displayed to the system user via a display unit or is automatically sent to a preset system user.

31. The computer-readable data carrier comprising instructions executable by computer processor for implementation of methods for generation of reports based on analysis of location and interaction of employees and visitors according to claim 16.
